(19) United States
(12) Patent Application Publication
(10) Pub. No.: US 2006/0224400 A1
(43) Pub. Date: Oct. 5, 2006

(54) Business event notifications on aggregated thresholds

(75) Inventors: Gueorgui B. Chkodrov, Redmond, WA (US); John D. Ballard, Woodinville, WA (US); Richard Z. Jason, Seattle, WA (US); David S. Taniguchi, Kirkland, WA (US); Derek Kee Hern Tan, Sammamish, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/097,003

(22) Filed: Apr. 1, 2005

(51) Int. Cl. G06Q 99/00

(52) U.S. Cl. 705/1

(57) ABSTRACT

A system and method for notifying a user of an event indicated by aggregated data relating to a status of activities, where the aggregated data is stored in a plurality of independently managed applications. An interface receives from the user an identification of an event relating to the aggregated data. The interface also receives from the user a threshold for the identified event. An aggregation component collects the aggregated data relating to the identified event. A notifying component notifies the user when the aggregated data collected by the aggregation component indicates that the threshold is satisfied. The system also includes a chronicle for recording values of past events and the notifying component notifies the user of the identified event as a function of the recorded values in the chronicle, aggregated data relating to the identified event and the threshold.

### TECHNICAL FIELD

Embodiments of the present invention generally relate to the field of business event notifications. In particular, embodiments of this invention relate to notifying a user of an event indicated by aggregated data indicating a status of business activities when the event exceeds a threshold.

### BACKGROUND OF THE INVENTION

Business entities engage in numerous activities based on a variety of automated processes (e.g., relying on computerized activities and business software applications) and operations based on human actions (e.g., phone calls, faxes, e-mails, etc.). As a result, obtaining an accurate snapshot of“what is going on with the business” becomes more complex and critical for businesses to make quick decisions to leverage market opportunities or to prevent losses.

Businesses and other organizations use computers, and in particular, computer database applications, to monitor and record information about organizational activities. Often, an organization will have recurring processes or activities that must be performed. Indeed, it is common for an organization to have numerous instances of an activity in various stages of completion at any given time. As one example, a business may sell goods based on orders received from customers. An activity of interest may be fulfilling those customer orders; each purchase order represents a separate instance of that activity. At any particular time, that business may have multiple instances of the activity (i.e., multiple orders from multiple customers) in various stages of completion. As another example, a financial institution may loan funds to customers based on applications from those customers. An activity of interest may be the processing of a loan application to completion (e.g., approval or rejection), with each loan application representing a separate instance of the activity. At any particular time, there may be multiple loan application instances in various stages of processing. As yet another example, a governmental entity responsible for issuing permits may have multiple permit applications in various stages of being processed.

In facilitating management of business activities, a system known as “Business Activity Monitoring” (BAM) concentrates and analyzes data from and for heterogeneous event sources in an attempt to present a single real-time view of the business state, status, trends, and critical conditions. Businesses or enterprise entities that successfully monitor business activities will be able to make decisions faster based on more relevant data, and therefore will gain significant advantage. Such a business that can make decisions in real-time is sometimes referred to as a “Zero Latency Enterprise” (ZLE).

Also, when a user wishes to monitor aggregated data relating to business activities, existing systems of BAM implementation may only provide an overview of the aggregated data. For example, a sales manager wishes to manage all purchase orders and may wish to know if there is a backlog or a long delay of approving purchase orders in all of its sales locations. In this case, some existing systems would only be able to present the sales manager an overview of the backlog or the long delay of approving purchase orders. That is, the systems provide a pie chart, a table, or other organizational diagrams to show how many purchase orders have not been approved in 3 days, 7 days, or the like.

On the other hand, other systems may provide alert or notification to the users relating to the monitored aggregated data determined by programmers who initially designed such systems. Using the sales manager example above, the system may send notification to the sales manager when there is a long backlog of approving purchase orders because there are 500 unapproved orders. However, such notification or alert in the existing system is hard-coded or configured by software programmers who initially designed the systems. As such, end users, such as the sales manager, lack the ability to set an alert or a notification on aggregated data according to her needs.

Accordingly, improvements in business event notifications on aggregated data in a distributed environment are desired to address one or more of these and other disadvantages by enabling end users to set and register alerts or notifications on aggregated data to meet their needs.

### SUMMARY OF THE INVENTION

Embodiments of the present invention overcome the deficiencies of prior art by providing the capability for an end user to register her desire to be notified when an event relating to a multi-dimensional aggregation data becomes less or greater than a given threshold. Embodiments of the present invention also provide efficient evaluation and analysis of the alerts that many users set on different sets of aggregated data and their corresponding thresholds. In addition, embodiments of the present invention facilitate registering thresholds on events of calculated aggregation.

According to one aspect of the invention, a method notifies a user of an event indicated by aggregated data relating to a status of activities in which the aggregated data is stored in a plurality of independently managed applications. An event relating to the aggregated data is identified. The aggregated data relating to the identified event is collected. A threshold for the identified event is registered. The user is notified when the collected data indicates that the event exceeds the registered threshold.

According to another aspect of the invention, a system notifies a user of an event indicated by aggregated data relating to a status of activities in which the aggregated data is stored in a plurality of independently managed applications. An interface receives from the user an identification of an event relating to the aggregated data, wherein said interface receives from the user a threshold for the identified event. An aggregation component collects the aggregated data relating to the identified event. A notifying component notifies the user when the aggregated data collected by the aggregation component indicates that the threshold is satisfied.

In accordance with a further aspect of the invention, one or more computer-readable media having computer-executable components notifies a user of an event indicated by aggregated data relating to a status of activities, wherein the aggregated data is stored in a plurality of independently managed applications. An interface receives from the user an identification of an event relating to the aggregated data, wherein said interface receives from the user a threshold for the identified event. An aggregation component collects the aggregated data relating to the identified event. A notifying component notifies the user when the aggregated data collected by the aggregation component indicates that the threshold is satisfied.

Alternatively, the invention may comprise various other methods and apparatuses.

Other features will be in part apparent and in part pointed out hereinafter.

### BRIEF DESCRIPTION OF THE DRAWINGS

FIG. 1 is a flow diagram illustrating an example of business event processing according to one embodiment of the invention.

FIG. 2 is a diagram illustrating an example of an aggregated data according to one embodiment of the invention.

FIG. 3 is an illustration of a screen display registering a threshold of an event relating to an aggregated data relating to a status of an activity according to one embodiment of the invention.

FIG. 4 is a diagram illustrating notifying a user of an event when a threshold is satisfied according to an existing model of the notification system.

FIG. 5 is a block diagram illustrating a system for notifying a user of an event indicated by aggregated data relating to a status of activities according to one embodiment of the invention.

FIG. 6 is a diagram illustrating notifying a user of an event relating to aggregated data when a threshold is satisfied according to one embodiment of the invention.

FIG. 7 is a diagram illustrating notifying or alerting a user according to a past event in a chronicle according to one embodiment of the invention.

FIG. 8 is a flow chart illustrating a method of notifying a user of an event relating to aggregated data according to one embodiment of the invention.

FIG. 9 is a block diagram illustrating one example of a suitable computing system environment in which the invention may be implemented.

Corresponding reference characters indicate corresponding parts throughout the drawings.

### DETAILED DESCRIPTION OF THE INVENTION

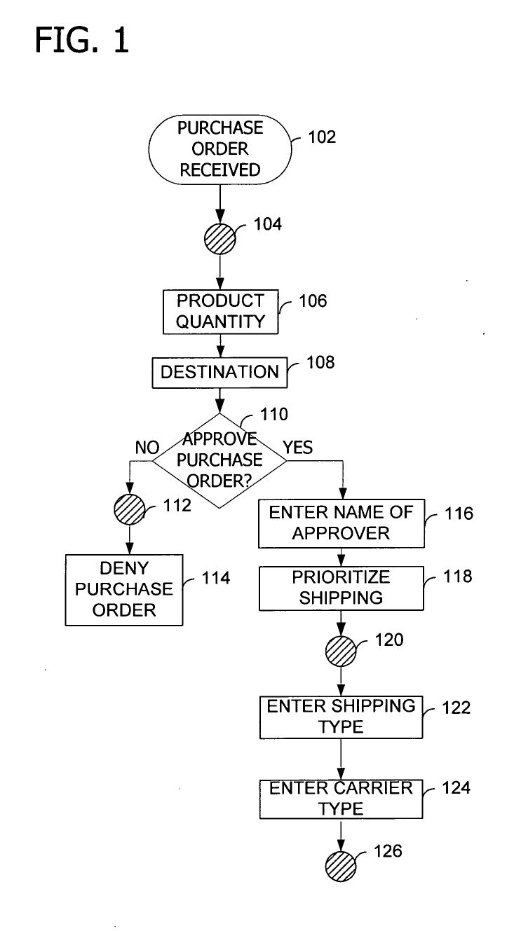

Referring first to FIG. 1, an exemplary flow diagram illustrates an example of a typical business event such as purchase order processing according to one embodiment of the invention. Business events include automated activities (e.g., completion of updating software applications, sales processes, or purchase order processing), physical activities (e.g., a truck driver delivering a package to a recipient), or a combination of both. In the illustrated embodiment, a purchase order is initially received at 102. It is to be understood that a plurality of instances of purchase orders may be received and each instance of purchase orders includes a set of data relating to the purchase order. In managing multiple instances of a business activity, one useful function is the ability to be notified of an event in the business activity. For example, one may be interested to be notified “When purchase orders exceed 1000 in any given 30-day period?“

At 104, the purchase order reaches a milestone and at this milestone, data of the purchase order is received or recorded. For example, data of the purchase order includes the date when purchase order was received, the name of the person who took the purchase order, the name of the person who placed the purchase order or the like. It is to be understood that the milestone at 104 may be a stage of completion of certain tasks. As discussed earlier, many instances of purchase order activity may be running simultaneously and each instance may reach different stages of completion. Advantageously, current time may be collected when a milestone is hit (e.g., at 104, 112, 120 and 126).

At 106, data relating to the product quantity of the purchase order is collected. At 108, data associated with the shipping destination identified in the purchase order is collected. At 110, a user determines whether to approve the purchase order. If the user determines to deny the purchase order, data of the time of the denial is collected at 112 and the decision to deny the purchase order is collected at 114. On the other hand, if the status of the purchase order is “approved”, data including the name of the approver is collected at 116 and shipping is prioritized at 118. Once again, the purchase order activity reaches a milestone 120 and data relating to time and/or other data is collected. Next, data associated with shipping type of the purchase order is entered or collected at 122 before at 124 when the carrier type data is collected. The purchase order activity reaches another milestone at 126.

While FIG. 1 describes a typical purchase order activity, it is to be understood that other business events with relevant milestones or stages of completions may be implemented without departing from the scope of the present invention. In addition, the types of data collected in describing FIG. 1 are used for exemplary purposes and not by means of limitations. Other operational data relating to a business event may be collected for future queries and analysis.

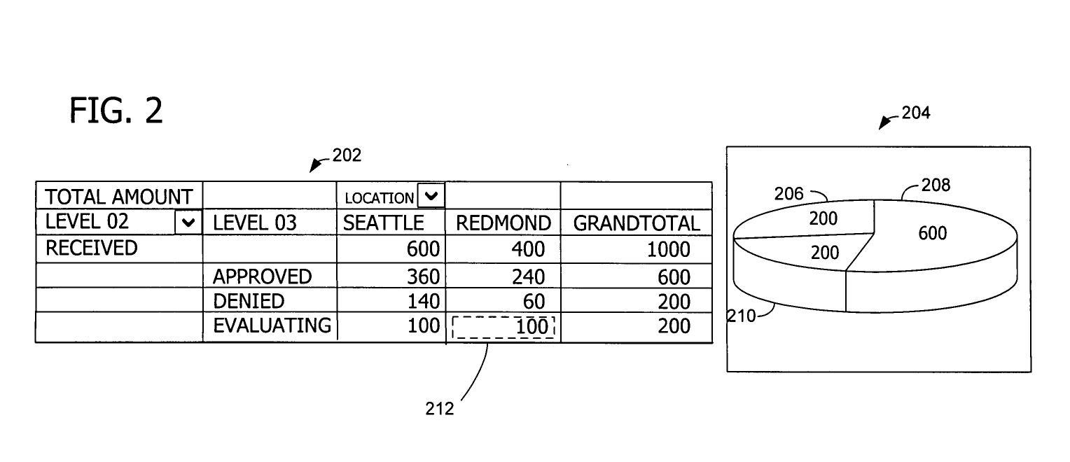

While data of each instance of a business activity is collected at various milestones, the user may wish to be notified or alerted based on the status of the aggregation of business activities. FIG. 2 is a diagram illustrating an example of an aggregated data according to one embodiment of the invention. As is known by those skilled in the art, data aggregation involves a process in which information is gathered and expressed in a summary form for further analysis. For example, instead of receiving non-aggregated sales data in a sales department (e.g., number of products sold in a given month), a sales manager may wish to analyze data to get more information about particular products based on specific variables such as age, product type, number of products sold, or the like. By aggregating the data from age, product type, and number of products sold, the sales manager may analyze the aggregated data to determine questions such as which age group purchases the most product type, or the like.

In one example, aggregated data from multi-dimensional databases or applications is organized using a star schema. A star schema is a database model where data is organized in fact tables and dimension tables. A fact table contains the measurements, metrics, or facts of business processes. For example, in a sales department, a measurement of the sales department business process may be “monthly sales number”. A dimension table includes context of measurements. Context of measurements may be the characteristics, such as who, what, where, when, how of a measurement. Using the sales department example above, context of the “monthly sales number” may include characteristics such as a Location (i.e., where), Time (i.e., when), Product Sold (i.e., what), or the like. In addition, a dimension table may include dimension attributes. For example, for a location dimension, dimension attributes may include a location code, city, state, country, zip code, or the like. By organizing data in fact tables and dimension tables, the sales manager may perform queries such as “How many cups of mocha latte have been sold in location code 1 (downtown Seattle) so far this year?”

Returning to FIG. 2, a table 202 illustrates an example of aggregated data showing purchase orders in a given period (e.g., a week). In this example, the table 202 contains a number of measures (e.g., summaries) and dimensions (e.g., categories that are used to group or filter summaries. For example, the aggregated data includes location measures with dimensions such as {Seattle, Redmond} and progress measures with dimensions such as {received, approved, denied, evaluation, shipped}. Other measures, such as time, include dimensions such as {year, month, day, etc.}, product measure includes dimensions such as {product ID, product description}, or the like may be included in table 202. The table 202 shows that 600 purchase orders were received at the Seattle office and 400 purchase orders were received at the Redmond office (with a grand total of 1000). Among the 600 received orders at Seattle, 360 orders were approved, 140 orders were denied and 100 orders are in the evaluation stage. Similarly, for the Redmond office, a total of 400 received orders includes 240 approved orders, 60 denied orders, and 100 of them are in the evaluation stage. This aggregated data is also illustrated in a pie chart 204 with portion 206 showing the total number of orders in the evaluation stage (200), portion 208 showing the total number of approved orders (600) and portion 210 showing the total number of denied orders (200).

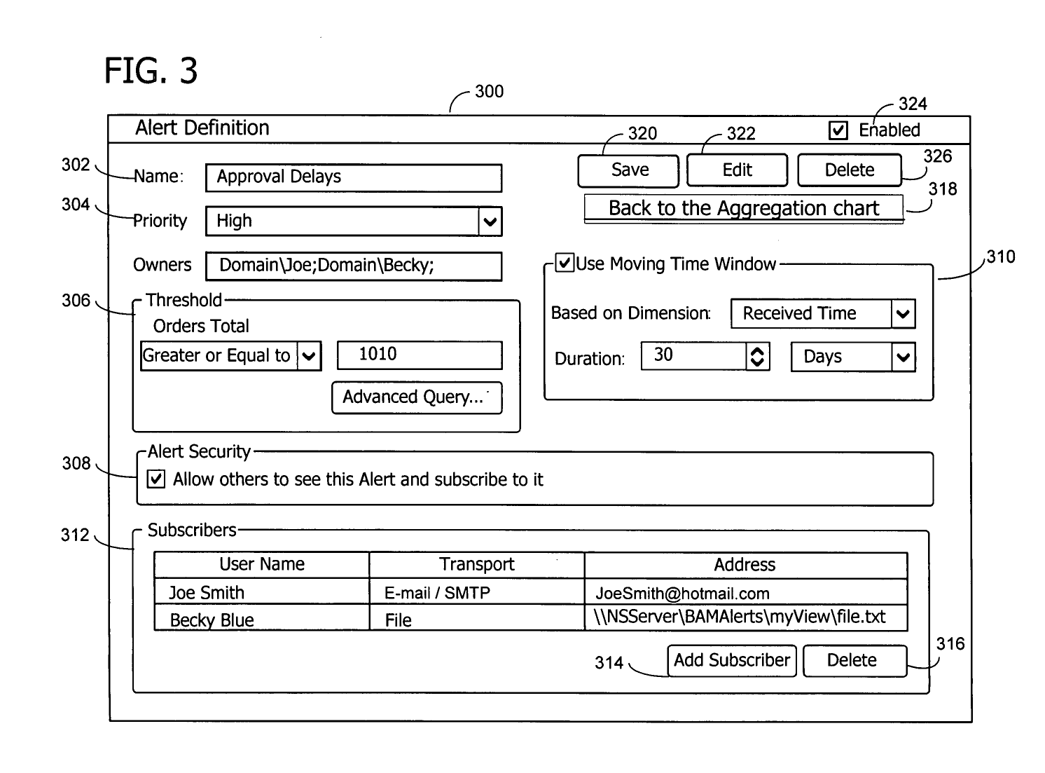

While having aggregated data allows management personnel to view the business activities efficiently, frequently users are interested in the value of specific aggregated data, such as the number of orders in the evaluation stage. As such, users wish to be notified when certain aggregated data that indicates a certain event in the business activities process needs attention. Using FIG. 2 as an example, a sales manager may wish to be alerted or notified when the number of orders in the evaluation stage in the Seattle office (i.e., cell 212) is over a threshold (e.g., 100 or more). When cell 212 has a-value that exceeds 100 (e.g., 150), this may indicate that there is a problem with purchase order approval process (e.g. because there are not enough people processing them). By selecting cell 212 (as shown by the dashed box), the user may register a threshold or a condition to monitor aggregated data in cell 212. For example, the user may double-click on the left button or click on the right mouse button and choose “Set Alert” option. FIG. 3 (to be described below) shows an exemplary screen display for setting an alert on aggregated data.

In another example, applications of embodiments of the present invention may be beneficial in healthcare industry. Patients are admitted to hospitals and they proceed to different departments to have their conditions treated. For example, if a patient is complaining of chest pains and calls for 911 for emergency, paramedics are dispatched. As the patient is transported to a hospital, paramedics may perform preliminary diagnosis of the patient's condition. Upon arrival at the hospital, a nurse may register the patient by inputting basic patient medical data during the registration process. The patient may be fitted with a bracelet and be directed to an emergency waiting room or a triage. The patient may next be attended to by a doctor or a cardiologist. Depending on the patient's condition, the patient may be released shortly after the treatment or may be required to stay in the hospital for further observation or treatment.

As the patient proceed through different stages of her treatment (e.g., from calling the 911 to being released from the hospital), hospital management personnel is interested in receiving notification of various events such as, excessive amount of time spent in waiting to be treated in emergency cases, the number of treatment procedure code errors, or the like. By defining milestones in the process (e.g. patient admitted, surgery performed, patient released, or the like), embodiments of the present invention collect and aggregate information about individual patients that have come in to the hospital during their treatment process. Hospital management may register thresholds for events relating to the collected aggregated data. For example, the hospital administrators may wish to know the efficiency of the radiology department. Embodiments of the present invention may alert the hospital administrators when the radiology department's average time for processing patients is 50% higher than it should to be. The aggregated data collected on the radiology department may provide an indication of more significant problems (e.g., staff shortage, frequent equipment malfunction, or the like). In another example, the administrators may wish to be alerted when some departments in the hospital receive a significantly high amount of entries of treatment procedure codes. In particular, embodiments of the present invention may alert the administrators only when there is a long delay for treatment of a specific procedure code or codes. It is to be understood that, with the analysis of the collected aggregated data, embodiments of the invention permit the administrators to monitor business activities and events and to be alerted when the monitored event exceeds a desired threshold.

Similarly, embodiments of the invention are beneficial to a human resource (HR) department which monitors the recruitment process. For example, a HR department manager may wish to know events such as how long various departments take to effectively interview candidates, how often a candidate is rejected in the initial stages of the recruiting process, how many overruns are occurring each week resulting in an extra day of processing and costs, or the like. Like the illustrated purchase order example in FIG. 1, data at various milestones relating to the recruiting process (e.g., initial interview, second interview, lunch or dinner with current employees, reimbursement of travel expenses, or the like) may be collected, and the HR manager may monitor the recruiting process by using the aggregated data to watch for trends or patterns that are only apparent at the aggregate level. For example, instead of learning that Smith has waited for three weeks after the initial interview to be invited for a second interview, the HR manager is more interested to know if it takes more than two weeks for 25 or more candidates to schedule a second interview. Likewise, the HR manager may also wish to be notified by events such as which department takes the longest to process a candidate, which schools are sending the highest number of successful candidates, how often referrals are the source, if it takes too long to pre-screen candidates (which can be indicative of a problem in recruiting that actually lowers the number of likely matches with open positions), or the like.

For another example, business activities or events may include customer service requests in the telecommunications industry. In this example, a given telecommunications company may receive thousands or millions of customer service requests per day for services such as activation of new service or service outage investigation. From the time the customer's request comes in to the customer service department to the time the service is performed, there are milestones along the way against which progress can be measured. By creating a simple sequence of process milestones (e.g. service request received, investigation initiated, investigation complete, corrective action initiated, or the like) and collecting data about the types of requests, a customer service manager may obtain a better sense of the quality of services provided to customers. It is much easier to anticipate and prevent customer dissatisfaction due to slow response to service requests if it is possible to have an aggregate view across all requests received. The aggregated data may show how long various remedial steps take, what types of requests tend to be more complicated to correct (and therefore demand better expectation setting), or the like. Instead of the common and existing approach of surveying customers to learn of their dissatisfaction, embodiments of the invention assist managers to identify where the process needs improvement by notifying or alerting the managers of events from aggregated data timely.

It is to be understood that above examples of business activities or events are used as examples and not as limitations. It is also to be understood that embodiments of the invention are not limited to business related activities or events; non-business activities that identify various stages of completion or milestones may also benefit from the present invention.

FIG. 3 is an illustration of a screen display 300 registering a threshold of an event relating to an aggregated data relating to a status of an activity according to one embodiment of the invention. Using the cell 212 in FIG. 2 as an example, the user uses the screen display 300 to register a threshold of 100 for the cell 212 to alert the user that orders in the evaluation stage is over 100 or more. In one embodiment, the threshold may be a discrete value, a range of values, or an iterative occurrence of values. In another embodiment, the threshold is a function of aggregated data or a function of a collection of aggregated data. For example, the threshold may be measured against a key performance indicator (KPI) which may be a function of aggregated data.

The user may first define a name for the notification at box 302. In this example, as the user wishes to monitor the total number of orders in Seattle in the evaluation stage, the user may use name “Approval Delays” in the box 302. The user also has the option to provide hierarchy of the alert, such as shown in box 304. For example, the user may set the priority to “high”. At box 306, the user registers the threshold for the aggregated data. In this example, the aggregated data of orders in the evaluation stage in the Seattle office is collected. The user may register a threshold of 1010 or more to monitor the order approval process. Alternatively, the user may also select the “Advanced Query . . . ” to register advance threshold conditions. For example, suppose a user wishes to set alert on purchase orders from the City of Bellevue. However, the user does not find such dimension value in the aggregated data. As a result, by selecting the “Advanced Query . . . ” button, the user is presented with additional choices to insert additional Threshold parameters, such as City=“Bellevue”.

The screen display 300 also provides other features such as alert security box 308 showing that the user may select or deselect whether to allow others to see this alert and subscribe to the same alert. A box 312 shows a list of subscribers and methods of alerting or notifying the subscribers. For example, the box 312 shows that Joe Smith wishes to be alerted by having the system send an email to him. On the other hand, Becky Blue wishes to be notified by sending a text file to her. Alternatively, the user may make changes to the subscribers box 312 by selecting button 314 “Add” to add a new subscriber or by selecting button 316 “Delete” to remove a subscriber.

The screen display 300 also shows a moving time window box 310 for the user to be alerted when the aggregated data is monitored over a period of time. For example, the user wishes to be alerted or notified if the approval delay occurs in any given thirty-day period. The user selects box 310 and learns that the aggregated data of the thirty-day period can be collected (e.g., from an aggregation of data from Time and Progress dimensions). Once the user is finished registering the threshold, the user selects either a “Save” button 320 to save the alert, an “Edit” button 322 to edit existing alert, or a “Delete” button 326 to delete an alert. Also, screen display 300 provides an option to the user to set the alert without enabling it by selecting or deselecting box 324. The user may also selects box 318 to return to an aggregation chart, such as the pie chart 204, from screen display 300.

It is to be understood that other features or options may be provided to the user on screen display 300 without departing from the scope of the present invention. For example, a warning dialog window may be displayed when the user selects “Delete” box 326 or a confirmation window may appear when the user tries to save the alert.

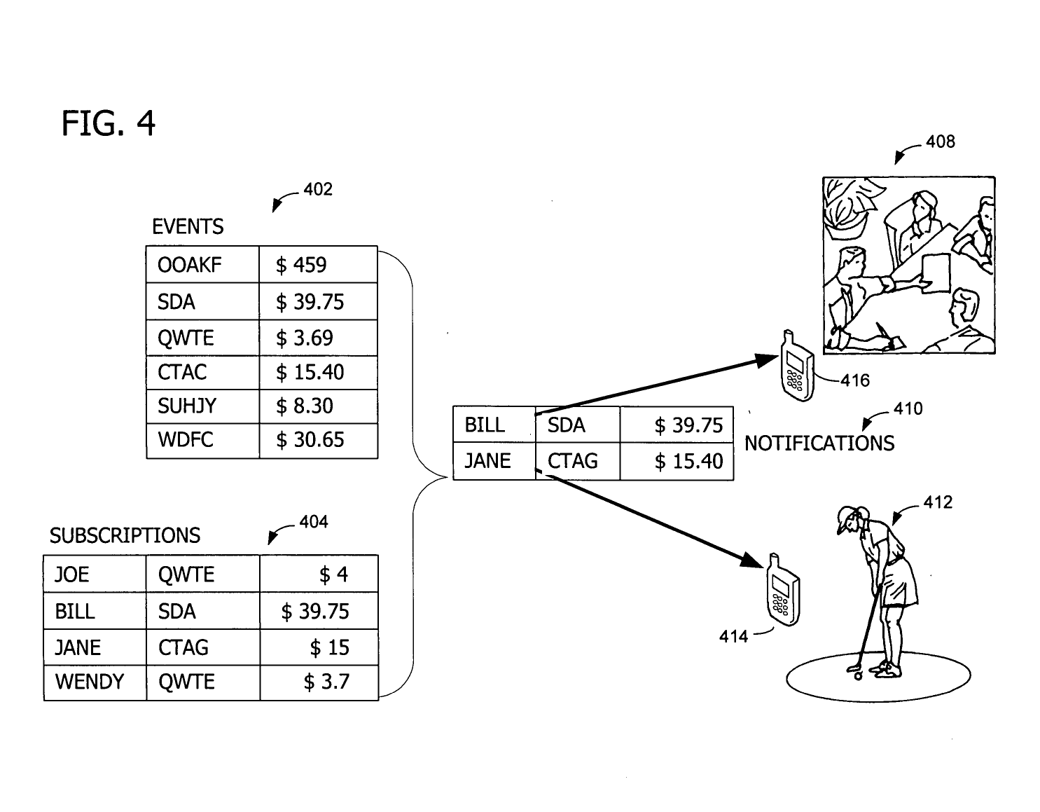

FIG. 4 is a diagram illustrating notifying a user of an event when a threshold is satisfied according to an existing model of the notification system. For example, currently there are many general purpose notification systems, such as SQL Notification Services application. For example, a user may wish to be notified when certain stocks reach certain prices. An events table 402 shows a list of stock symbols with their respective stock prices. For example, the events table 402 shows that stocks represented by the stock symbol “SDA” is currently being traded at $39.75 per share while the stock represented by the symbol “CTAG” is being traded at $15.40 per share. A subscriptions table 404 shows a number of users who wishes to be alerted when the prices of their stocks reach a certain value. For example, Bill 408 wishes to be alerted when the stock (denoted by stock symbol “SDA”) reaches $39.75 per share. Similarly, Jane 412 wishes to be notified when the per share value of the stock “CTAG” reaches $15.00. As a particular example, in order to alert Bill 408 and Jane 412 when SDA stock reaches $39.75 and CTAG reaches $15.00, respectively, a single execution of query statements against both tables may be implemented using Structured Query Language (SQL) statements below:

SELECT s.Name, e.Symbol, e.Price

FROM Events e JOIN Subscriptions s

ON

e.Symbol=s.Symbol AND

e.Price>s.Price

That is, according to the notifications 410, Bill 408 will be notified on his cell phone or a portable communications device 416 when the stocks “SDA” reaches $39.75 per share while Jane 412 will be alerted on her portable communications device 414 when the stocks “CTAG” reaches $15.00 per share.

While existing systems provide an alert or a notification capability, such systems are fall short in allowing the end users to register individual alerts or notifications. Notifications or alerts in the current systems customarily are hard-coded or configured by software programmers who initially design the systems. As a result, these systems lack the flexibility to allow end users define and register notifications or alerts based on aggregated data of interest. For example, in existing systems, it is assumed that the events table 402, the subscriptions table 404 and the notifications table 410 are managed and controlled in the same database or under the same software application, such as Bill and Jane are customers of the same security brokerage firm. However, if Bill or Jane wishes to be notified based on the aggregated data, he or she could not modify the notifications or alerts because these notifications or alerts have already been set by software programmers. Bill or Jane could only view a chart or a summary overview of notifications based on aggregated data.

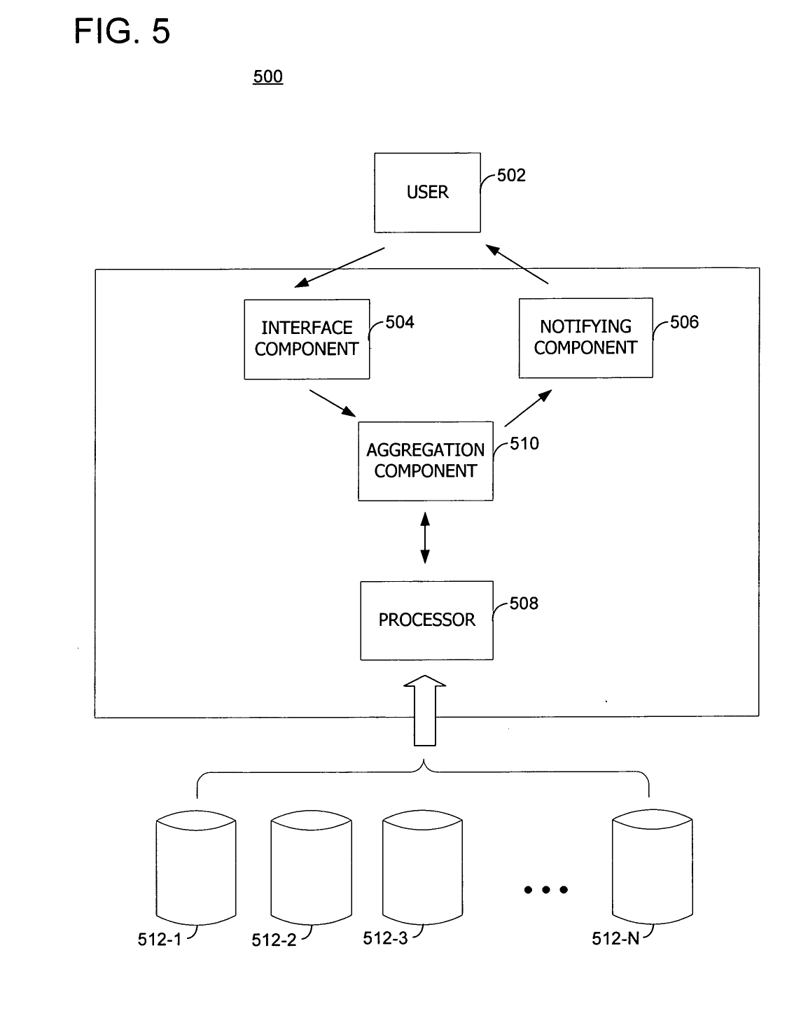

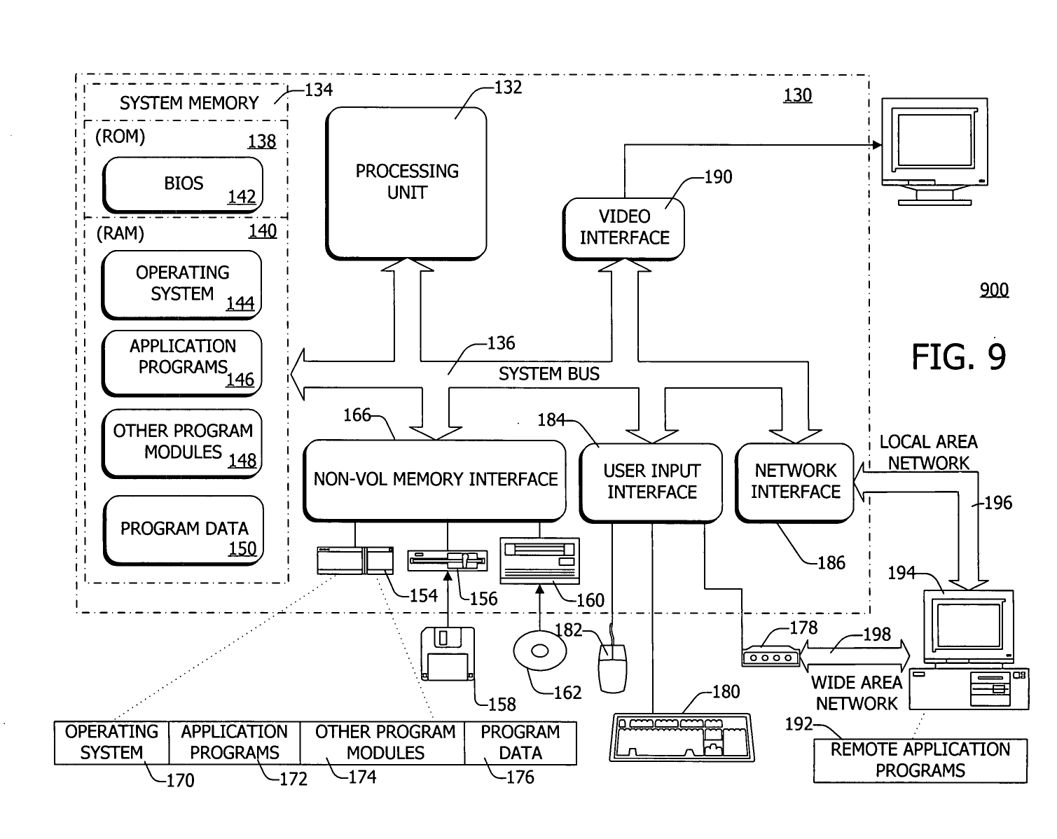

FIG. 5 is a diagram illustrating a system 500 for notifying a user 502 of an event indicated by aggregated data relating to a status of business activities according to one embodiment of the invention. The system 500 may be a server, a personal computer (e.g., system 130 in FIG. 9), a minicomputer, one or more servers, or a mainframe that provides data management, sophisticated network administration, security features or information sharing with another server. Initially, in order to access data in multiple and/or independently managed applications 512, system 500 defines relationships between data stored in a first application 512-1 and data stored a second application 512-2. The data in the first application 512-1 and the second application 512-2 is aggregated and monitored as a function of the defined relationships. That is, events from the first application 512-1 are correlated with events from the second application 512-2 and the events from the first application 512-1 and the second application 512-2 are aggregated by an aggregation component 510 (to be further discussed in detail below). Assume the user 502 wishes to be notified or alerted of an event when the aggregated data indicates that a threshold is satisfied. Initially, an interface 504 receives from the user an identification of the event relating to the aggregated data. For example, the interface 504 may be a graphical user interface (GUI) such as the table 202 showing the aggregated data. The user 502 may select cell 212 (as shown by the dashed box in FIG. 2) to indicate that the user wishes to define an event based on the aggregated value collected in cell 212 and to set an alert when the aggregated data indicates that the event has occurred. Upon selecting cell 212, interface 504 may display an alert definition dialog window (e.g., screen display 300) for user 502 to register a threshold or other conditions. Using FIG. 3 as an example, the user 502 may register a threshold of 100 for cell 212 so that she may be alerted when purchase orders in the evaluation stage for the Seattle office reaches 100.

The aggregation component 510 receives from interface 504 the identified event. The aggregation component 510 may be one or more software applications that access data stored in applications 512 and configure computer-executable instructions relating to the identified event. For example, after receiving the identified event from interface 504, aggregation component 510 formulates and configures a set of computer-executable instructions to collect the aggregated data relating to the identified event. Using FIG. 2 as an example, the aggregation component 508 determines a set of computer-executable instructions to collect aggregated data stored in “Progress”, “Time”, and “Location” dimensions in applications 512 to monitor whether the threshold value of 100 is satisfied. It is to be understood that the user 502 may identify the event in real-time and the aggregation component 510 would formulate and configure a set of computer-executable instructions to collected the aggregated data relating to the identified event. In another embodiment, other dimensions or multi-dimensional aggregation data may be collected to monitor events identified by user 502. It is to be understood that aggregation component 510 may collect the aggregated data from applications 512 over a period of time.

The aggregation component 510 communicates the set of computer-executable instructions to a processor 508 to execute the instructions. For example, the processor 508 maybe a processing unit 132 of FIG. 9, one or more processors, or other type of device that processes computer-executable instructions. After processor 508 executes the set of computer-executable instructions and returns the results to aggregation component 510, aggregation component 510 determines whether the threshold is satisfied. If aggregated data indicates the threshold is satisfied, aggregation component 510 communicates such occurrence to a notification component 506 such that the notification component 506 may notify or alert user 502 that the identified event has occurred. For example, when there are 100 or more purchase orders in the evaluation stage at the Seattle office, user 502 (e.g., sales manager) would be alerted and appropriate remedial measures may take place.

While system 500 includes components depicted in FIG. 5 (e.g., interface 504, processor 508, or the like), it is to be understood that additional component or components may be included and such configuration does not depart from the scope of the present invention.

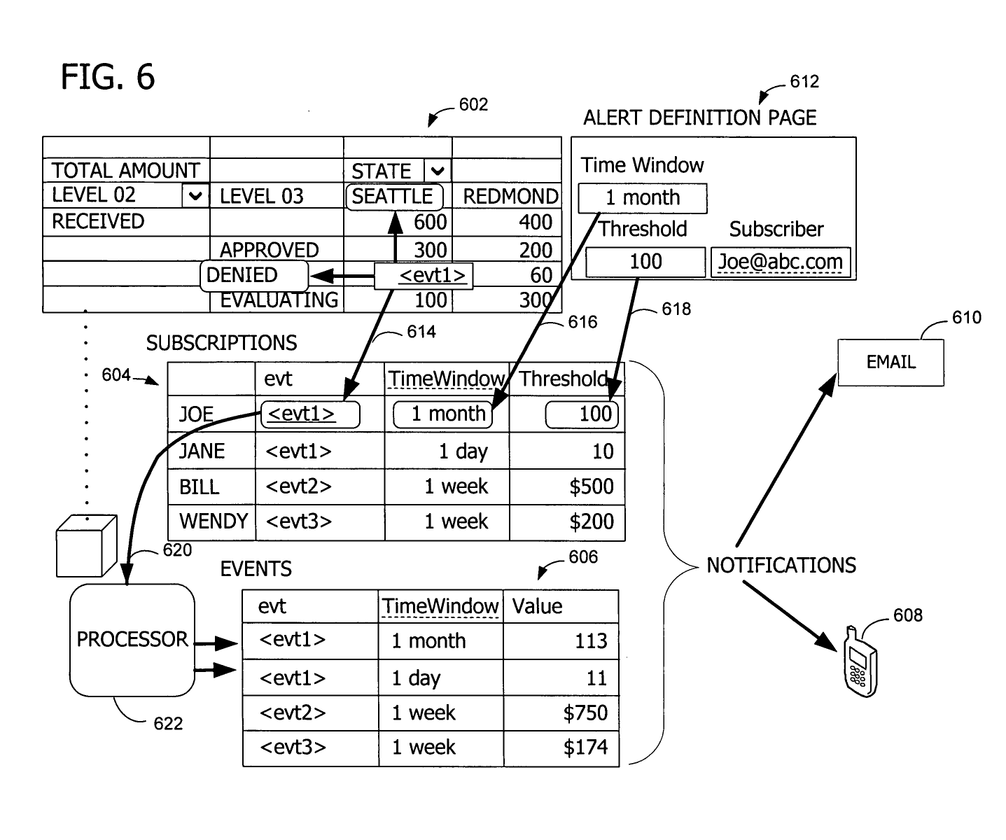

FIG. 6 illustrates a diagram showing an example of notifying a user of an event relating to an aggregated data when a threshold is satisfied according to one embodiment of the invention. In this example, a table 602 shows a portion of aggregated data (e.g., table 202). In this example, the user wishes to be notified by identifying an event of when denied orders in the Seattle office exceed 100. In one embodiment, a set of Multidimensional Expressions (MDX) statements described below may be used to alert the user when the identified event has occurred:

SELECT

{[Location].[All Location].[WA].[Seattle]} ON COLUMNS,

{[PoProgress].[All Progress].[All].[Denied]} ON ROWS

FROM PurchaseOrderCube

For example, unlike the events table 302 tracking stock prices, embodiments of the invention collect aggregated data from multiple dimensions stored in one or more databases or applications. This aggregated data is next stored in a subscriptions table 604. For example, the “<evt1>” cell in table 602 is stored in a cell “<evt1>” in table 604 (as shown by arrow 614). Also, after identifying the event, the user may register a threshold in an alert definition page 612 (e.g., screen display 300). In this example, the user sets that the aggregated data is to be monitored for a thirty-day period. He also registers a threshold of 100 denied orders in the Seattle office and wishes to have the notification send to his email address. The threshold and the time window period are also stored in the subscriptions table 604 (as shown by arrows 616 and 618 respectively). In one embodiment, more than one user may register different thresholds and set different time-window periods on the same cell of aggregated data. For example, in the subscriptions table 604, Jane has also set an alert on the same event (i.e., denied order in the Seattle office), but unlike Joe, she has registered a daily threshold of 10.

An events table 606 shows a list of identified events for different users. For example, both Joe and Jane have identified the same event (denoted by “<evt1>”) while Bill and Wendy have identified events <evt2> and <evt3> respectively. Also, as shown in the events table 606, <evt1> has reached a thirty-day value of 113 and a daily value of 11. As a result, a processor 622 (e.g., processor 508) receives the aggregated data and executes alerts (as shown by arrow 620) to be sent to Joe and Jane because the aggregated data indicates that the event has occurred. As such, the notification component 506 notifies Joe of the event to his email address at 610 and notifies Jane of the event to her portable communications device 608.

In other words, embodiments of the invention facilitate notifying users of events of interest by collecting aggregated data. For example, a sales department manager may wish to be notified when orders in all locations in the evaluation process exceed 100. Embodiments of the invention collect aggregated data, such as data relating to orders in evaluation process in locations (e.g., Seattle, Redmond, or the like). As a result, the sales manager would be notified or alerted when the orders in the evaluation process in all locations exceed 100. The use of alerts on business conditions or activities reflected by aggregations of process data is applicable to many scenarios. For example, credit card charges on the same account on different continents within five minutes may indicate a fraud has occurred. Similarly, thousands of such occurrences may constitute some kind of cyber attack or other theft tactic. Aggregating data and issuing alerts or notifications based on the aggregate data are valuable and beneficial to everyday businesses.

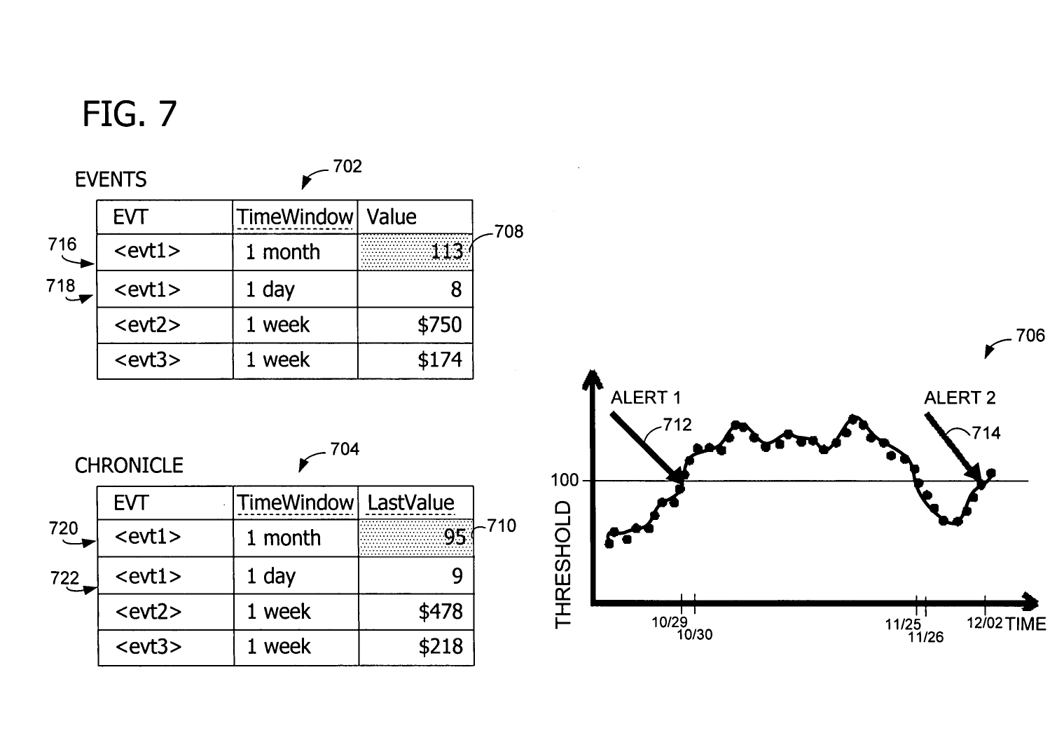

In another embodiment, a chronicle or a set of previous values of events may be used in conjunction with notifying a user of an event relating to aggregated data. FIG. 7 is a diagram illustrating notifying or alerting a user by comparing to data of a past event in a chronicle according to one embodiment of the invention. An events table 702 shows a list of events each having a corresponding time-window period and a corresponding threshold value. For example, <evt1> in row 716 has a time-window of 1 month and a threshold value of 113 (e.g., cell 708) while <evt1> in row 718 has a time-window of 1 day and a threshold value of 8. As explained previously, the same event (e.g., evt1) may be monitored by more than one individual with different set of time-window period and a different threshold value. A chronicle table 704 records the previous value of the identified event in the same time-window period. For example, in row 720, the previous one-month value of <evt1> was 95 (e.g., cell 710) while the same event <evt1> in row 722 has a previous one-day value of 9. It is to be understood that the chronicle 704 may be implemented by using data structures other than a table and such implementation does not depart from the scope of the invention.

The chronicle 704 is beneficial in the following illustrated situation. Suppose the user wishes to be alerted when the denied orders in the Seattle office exceeds 100 within a 30-day window. From the period between September 30 and October 29, such an event occurred when the denied orders reach 120 on October 29. As a result, the user is notified. The next day, on October 30, the denied orders continue to exceed the threshold of 100. While the user may need to be reminded of the problem, the user may be in the process of remedying the problem. As such, it is likely that he wishes not to be notified again because he has become aware of the problems.

Therefore, chronicle 704 provides this feature by notifying the user as a function of the aggregated data, the threshold and a recorded past value of the identified event. As shown in a line graph 706, the aggregated data relating to the identified event (on the vertical axis) is plotted against time (on the horizontal axis). In this example, the line graph 706 represents aggregated data values relating to event <evt1> measured in any given 30-day time-window. A threshold of 100 is shown as a horizontal line indicating points above the line exceed the threshold. On October 29, the identified event (e.g., the denied order in the Seattle office) has occurred with a value of 101 and alert 1 (shown by arrow 712) notified the user. On October 30, the aggregated data continues to show a value (e.g., 103) exceeding the threshold. With chronicle 704, instead of continuing to notify the user, embodiments of the invention records the previous value (i.e., 101) in chronicle 704 and determines that the present value of the aggregated data and the recorded value are both above the threshold. As a result, the user would not be notified. Similarly, as shown in line graph 706, the aggregated data relating to the identified event continues to satisfy the threshold from October 30 to November 25, and the user would not be notified during this period. On November 26, the aggregated data shows the value (e.g., 95) is below the threshold. Because the threshold is not satisfied, the user would not be notified. On December 2, however, the aggregated data shows a value (e.g., 105) satisfying the threshold and, as such, the user would be notified by alert 2 (as shown by arrow 714) that the identified event has occurred.

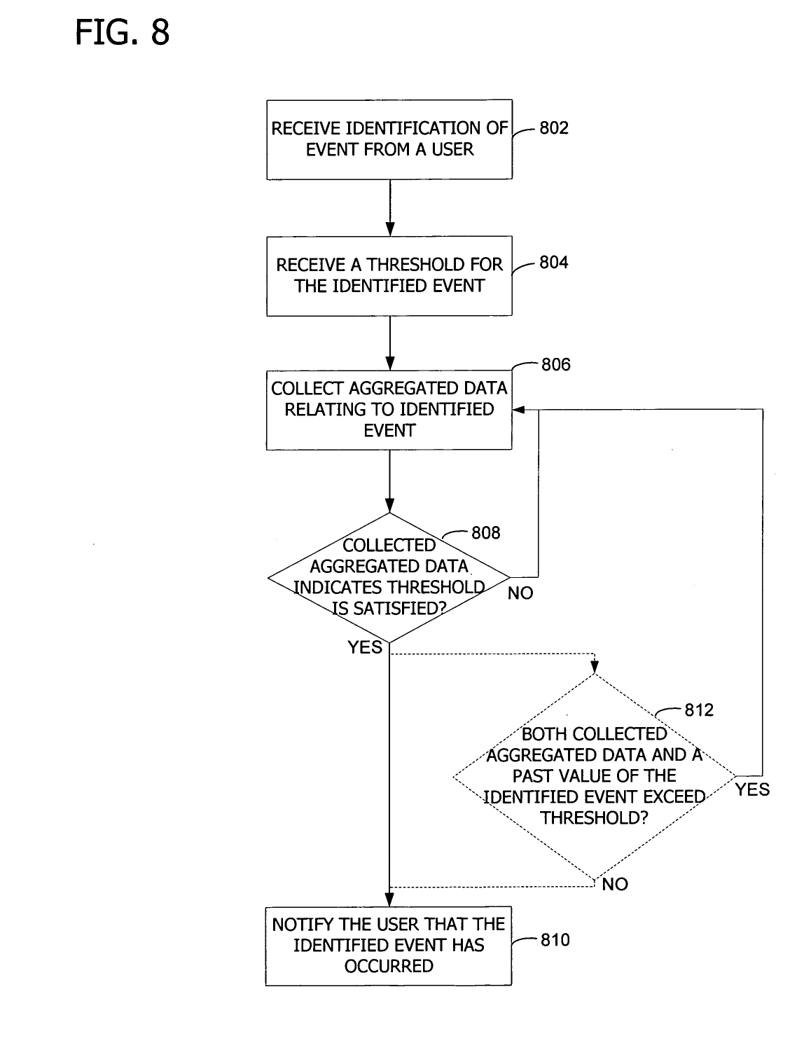

FIG. 8 is a flow chart illustrating a method of notifying a user of an event relating to aggregated data according to one embodiment of the invention. At 802, system 500 receives from the user an identification of an event relating to the aggregated data. For example, the user 502 identifies the event of denied orders in the Seattle office and wishes to receive notification when such an event occurs. As such, system 500 receives a threshold for the identified event (such as defining the threshold for denied orders at 100) at 804. At 806, system 500 collects the aggregated data relating to the identified event. At 808, system 500 determines whether the collected aggregated data indicates that the threshold is satisfied. If the determination is positive, system 500 notifies the user that the identified event has occurred at 810. Alternatively, if the determination is negative, system 500 returns to 808 and continues to collect aggregated data of the identified event. In another embodiment where a chronicle is used (e.g., chronicle 704), 812 would be positioned between 808 and 810. After 810 at 812, system 500 determines whether both the collected aggregated data and a past value of the identified event exceed the threshold. If the determination is positive, the user would not be notified and the system returns to 808. If the determination is negative, the user would be notified at 810.

FIG. 9 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 9 illustrates operating system 144, application programs 146, other program modules 148, and program data 150.

The computer 130 may also include other removable/non-removable, volatile/nonvolatile computer storage media. For example, FIG. 9 illustrates a hard disk drive 154 that reads from or writes to non-removable, nonvolatile magnetic media. FIG. 9 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 9, provide storage of computer readable instructions, data structures, program modules and other data for the computer 130. In FIG. 9, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 9 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 9 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above system and method without departing from the scope of the invention, it is intended that all matter contained in the above description and shown in the accompanying drawings shall be interpreted as illustrative and not in a limiting sense.

What is claimed is:

1. A method for notifying a user of an event indicated by aggregated data relating to a status of activities, wherein the aggregated data is stored in a plurality of independently managed applications, said method comprising:
identifying an event relating to the aggregated data;
collecting the aggregated data relating to the identified event;
registering a threshold for the identified event; and
notifying the user when the collected data indicates that the event exceeds the registered threshold.

2. The method of claim 1 further comprising notifying the user of the identified event as a function of the aggregated data of the identified event, the threshold and a past event.

3. The method of claim 1 wherein the aggregated data includes multi-dimensional aggregation data and wherein collecting comprises collecting the multi-dimensional aggregation data.

4. The method of claim 1 further comprising maintaining a subscription of a plurality of users each having an identified event and a corresponding threshold.

5. The method of claim 1 wherein the event is a function of a status of activities.

6. The method of claim 1 wherein collecting comprises collecting the aggregated data over a period of time to identify the event.

7. The method of claim 1 wherein identifying comprises identifying an event relating to the aggregated data by an user via a user interface (UI).

8. The method of claim 1 wherein one or more computer-readable media have computer-executable instructions for performing the method recited in claim 1.

9. A system for notifying a user of an event indicated by aggregated data relating to a status of activities, wherein the aggregated data is stored in a plurality of independently managed applications, said system comprising:
an interface for receiving from the user an identification of an event relating to the aggregated data, wherein said interface receives from the user a threshold for the identified event;
an aggregation component for collecting the aggregated data relating to the identified event; and
a notifying component for notifying the user when the aggregated data collected by the aggregation component indicates that the threshold is satisfied.

10. The system of claim 9 further comprising a chronicle for recording values of past events and wherein the notifying component notifies the user of the identified event as a function of the recorded values in the chronicle, aggregated data relating to the identified event and the threshold.

11. The system of claim 9 wherein the aggregated data includes multi-dimensional aggregation data and wherein the aggregation component collects the multi-dimensional aggregation data.

12. The system of claim 9 further comprising a subscription for recording a plurality of users each having an identified event and a corresponding threshold.

13. The system of claim 9 wherein the event is a function of a status of activities.

14. The system of claim 9 wherein the aggregation component collects the aggregation data over a period of time for the identified event identified by the identification component.

15. One or more computer-readable media having computer-executable components for notifying a user of an event indicated by aggregated data relating to a status of activities, wherein the aggregated data is stored in a plurality of independently managed applications, said components comprising:
an interface for receiving from the user an identification of an event relating to the aggregated data, wherein said interface receives from the user a threshold for the identified event;
an aggregation component for collecting the aggregated data relating to the identified event; and
a notifying component for notifying the user when the aggregated data collected by the aggregation component indicates that the threshold is satisfied.

16. The computer-readable media of claim 15 further comprising a chronicle for recording values of past events and wherein the notifying component notifies the user of the identified event as a function of the recorded values in the chronicle, aggregated data relating to the identified event and the threshold.

17. The computer-readable media of claim 15 wherein the aggregated data includes multi-dimensional aggregation data and wherein the aggregation component collects the multi-dimensional aggregation data.

18. The computer-readable media of claim 15 further comprising a subscription for recording a plurality of users each having an identified event and a corresponding threshold.

19. The computer-readable media of claim 15 wherein the event is a function of a status of activities.

20. The computer-readable media of claim 15 wherein the aggregation component collects the aggregated data over a period of time for the identified event identified by the identification component.
